(19) United States
(12) Patent Application Publication
(10) Pub. No.: US 2021/0050868 A1
(43) Pub. Date: Feb. 18, 2021

(54) TECHNIQUES FOR CONCURRENT MULTI-RAT RECEPTION BASED ON SWITCHED DIVERSITY

(71) Applicant: QUALCOMM Incorporated, San Diego, CA (US)

(72) Inventors: Haim Mendel WEISSMAN, Haifa (IL); Gideon Shlomo KUTZ, Ramat Hasharon (IL); Alexander Vladimir SVERDLOV, Rehovot (IL); Michael LEVITSKY, Rehovot (IL); Balasubramanian RAMACHANDRAN, Hyderabad (IN); Sharon GRAIF, Zichron Yaakov (IL)

(21) Appl. No.: 16/947,685

(22) Filed: Aug. 12, 2020

(30) Foreign Application Priority Data
Aug. 16, 2019 (IN) 201941033103

(51) Int. Cl. H04B 1/00; H04B 1/16; H04W 88/06

(52) U.S. Cl. CPC H04B 1/005; H04W 88/06; H04B 1/16

(57) ABSTRACT

Various aspects of the present disclosure generally relate to wireless communications. In some aspects, a user equipment (UE) may receive a first signal associated with a first radio access technology (RAT) and receive a second signal associated with a second RAT. In some aspects, the UE may include one or more receiver chains associated with the first RAT and at least one receiver chain associated with the second RAT. The UE may couple, via one or more switches and based at least in part on respective energy levels associated with the first signal and the second signal satisfying one or more conditions, an output from a front end of the at least one receiver chain associated with the second RAT to the one or more receiver chains associated with the first RAT. Numerous other aspects are provided.

### CROSS-REFERENCE TO RELATED APPLICATION

This patent application claims priority to India Patent Application No. 201941033103, filed on Aug. 16, 2019, entitled “TECHNIQUES FOR CONCURRENT MULTI-RAT RECEPTION BASED ON SWITCHED DIVERSITY,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for concurrent multiple radio access technology (multi-RAT) reception based on switched diversity.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication, performed by a user equipment (UE), may include receiving a first signal associated with a first radio access technology (RAT); receiving a second signal associated with a second RAT; and coupling, via one or more switches and based at least in part on respective energy levels associated with the first signal and the second signal satisfying one or more conditions, an output from a front end of at least one receiver chain associated with the second RAT to one or more receiver chains associated with the first RAT.

In some aspects, the method may further include estimating a first energy level associated with the first signal and a second energy level associated with the second signal, wherein the one or more conditions are satisfied when the first energy level fails to satisfy a first threshold and the second energy level satisfies a second threshold, or when a ratio of the first energy level to the second energy level fails to satisfy a third threshold.

In some aspects, the method may further include: estimating the energy level associated with the first signal after a first automatic gain control (AGC) iteration performed prior to coupling the output from the front end of the at least one receiver chain associated with the second RAT to the one or more receiver chains associated with the first RAT; estimating the energy level associated with the first signal after a second AGC iteration performed after coupling the output from the front end of the at least one receiver chain associated with the second RAT to the one or more receiver chains associated with the first RAT; and determining whether to maintain the coupling of the output from the front end of the at least one receiver chain associated with the second RAT to the one or more receiver chains associated with the first RAT based at least in part on a comparison of the energy level associated with the first signal after the first AGC iteration and the energy level associated with the first signal after the second AGC iteration.

In some aspects, the method may further include maintaining the coupling of the output from the front end of the at least one receiver chain associated with the second RAT to the one or more receiver chains associated with the first RAT based at least in part on the energy level associated with the first signal after the first AGC iteration exceeding the energy level associated with the first signal after the second AGC iteration.

In some aspects, the method may further include decoupling, via the one or more switches, the output of the front end of the at least one receiver chain associated with the second RAT from the one or more receiver chains associated with the first RAT based at least in part on the energy level associated with the first signal after the first AGC iteration failing to exceed the energy level associated with the first signal after the second AGC iteration.

In some aspects, the first AGC iteration and the second AGC iteration are performed within a single symbol of a subframe.

In some aspects, the coupling of the output from the front end of the at least one receiver chain associated with the second RAT to the one or more receiver chains associated with the first RAT is maintained for at least a duration of the subframe.

In some aspects, the first AGC iteration is performed while the UE is operating the at least one receiver chain at a start gain that covers a portion of an overall wideband energy estimation dynamic range, and the method further comprises selecting, among multiple antennas, an antenna that provides a maximum ratio or a maximum energy level for the first signal based at least in part on the first AGC iteration.

In some aspects, the second AGC iteration is performed while the UE is operating the at least one receiver chain at a second gain, and the method further comprises selecting, within the overall wideband energy estimation dynamic range, a final gain providing the maximum ratio or the maximum energy level for the first signal based at least in part on the second AGC iteration.

In some aspects, the one or more switches couple the output from the front end of the at least one receiver chain associated with the second RAT to the one or more receiver chains associated with the first RAT between an external low noise amplifier and an internal low noise amplifier in a path from an antenna to an analog-to-digital converter.

In some aspects, the one or more receiver chains associated with the first RAT include a main receiver chain and a diversity receiver chain that are dedicated to the first RAT.

In some aspects, the one or more receiver chains associated with the first RAT include a main receiver chain and a diversity receiver chain that share antennas and front ends with a set of receiver chains associated with the second RAT.

In some aspects, the one or more switches include one or more single pole single throw switches that cause the output from the front end of the at least one receiver chain to be coupled to the one or more receiver chains associated with the first RAT.

In some aspects, the one or more switches include one or more single pole single throw switches that cause the output from the front end of the at least one receiver chain to be decoupled from a receive path associated with the second RAT.

In some aspects, the one or more switches include one or more single pole double throw switches that enable the one or more receiver chains associated with the first RAT to be coupled to either the output from the front end of the at least one receiver chain associated with the second RAT or a front end of the one or more receiver chains associated with the first RAT.

In some aspects, the output from the front end of the at least one receiver chain is coupled to a splitter device having a first port that couples to a receive path associated with the second RAT and a second port that couples to the one or more receiver chains associated with the first RAT.

In some aspects, the second port that couples to the one or more receiver chains associated with the first RAT is terminated with one or more resistive devices when each of the one or more switches that couple the output from the front end of the at least one receiver chain to the one or more receiver chains associated with the first RAT are in an open state.

In some aspects, the first RAT is a Long Term Evolution RAT and the second RAT is a New Radio RAT.

In some aspects, the coupling causes the at least one receiver chain associated with the first RAT and the one or more receiver chains associated with the second RAT to be coupled to a dedicated antenna associated with the second RAT, and the coupling further causes the at least one receiver chain associated with the second RAT to be cross-coupled to a shared antenna associated with the first RAT and the second RAT.

In some aspects, a UE for wireless communication may include a memory and one or more processors operatively coupled to the memory. The memory and the one or more processors may be configured to receive a first signal associated with a first RAT; receive a second signal associated with a second RAT; and couple, via one or more switches and based at least in part on respective energy levels associated with the first signal and the second signal satisfying one or more conditions, an output from a front end of at least one receiver chain associated with the second RAT to one or more receiver chains associated with the first RAT.

In some aspects, a non-transitory computer-readable medium may store one or more instructions for wireless communication. The one or more instructions, when executed by one or more processors of a UE, may cause the one or more processors to: receive a first signal associated with a first RAT; receive a second signal associated with a second RAT; and couple, via one or more switches and based at least in part on respective energy levels associated with the first signal and the second signal satisfying one or more conditions, an output from a front end of at least one receiver chain associated with the second RAT to one or more receiver chains associated with the first RAT.

In some aspects, an apparatus for wireless communication may include means for receiving a first signal associated with a first RAT; means for receiving a second signal associated with a second RAT; and means for coupling, based at least in part on respective energy levels associated with the first signal and the second signal satisfying one or more conditions, an output from a front end of at least one receiver chain associated with the second RAT to one or more receiver chains associated with the first RAT.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of a transmit chain and a receive chain of a UE, in accordance with various aspects of the present disclosure.

FIGS. 4A-4B are diagrams illustrating an example implementation of concurrent reception of multiple radio access technologies (RATs) based on switched diversity, in accordance with various aspects of the present disclosure.

FIGS. 5A-5C are diagrams illustrating an example implementation of concurrent multi-RAT reception based on switched diversity, where a UE has one or more antennas and one or more receiver chains that are shared among different RATs, in accordance with various aspects of the present disclosure.

FIGS. 6A-6C are diagrams illustrating an example implementation of concurrent multi-RAT reception based on switched diversity, where a UE has independent antennas and independent receiver chains for multiple different RATs, in accordance with various aspects of the present disclosure.

FIG. 7 is a diagram illustrating an example circuit for enabling concurrent multi-RAT reception based on dynamic selection between a switched diversity mode and a combined diversity mode, in accordance with various aspects of the present disclosure.

FIGS. 8A-8B are diagrams illustrating examples associated with concurrent multi-RAT reception based on switched diversity, in accordance with various aspects of the present disclosure.

FIG. 9 is a diagram illustrating an example process performed, for example, by a UE, in accordance with various aspects of the present disclosure.

FIG. 10 is a block diagram of an example apparatus for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

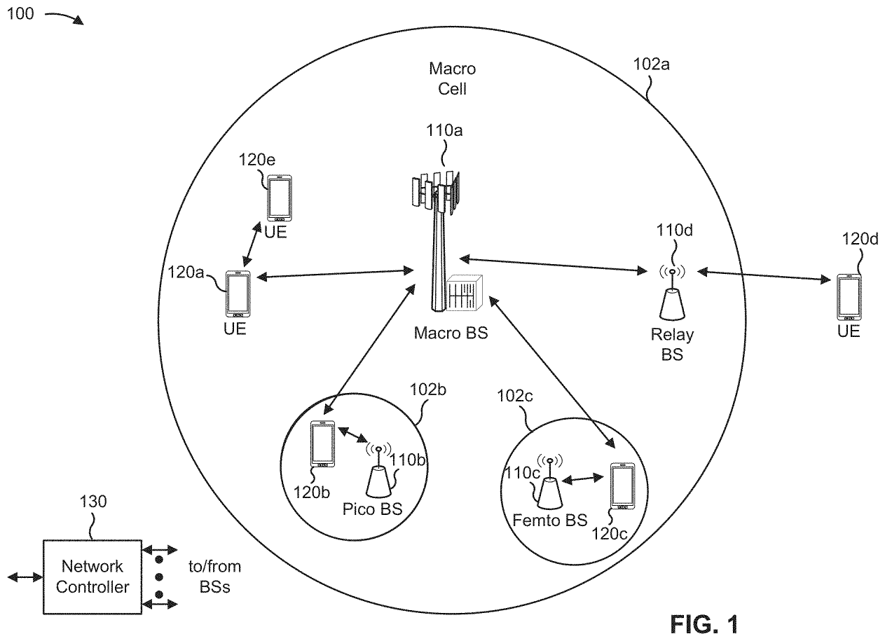

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another (e.g., directly or indirectly, via a wireless or wireline backhaul).

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, a vehicle-to-pedestrian (V2P) protocol, a vehicle-to-network (V2N) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with respect to FIG. 1.

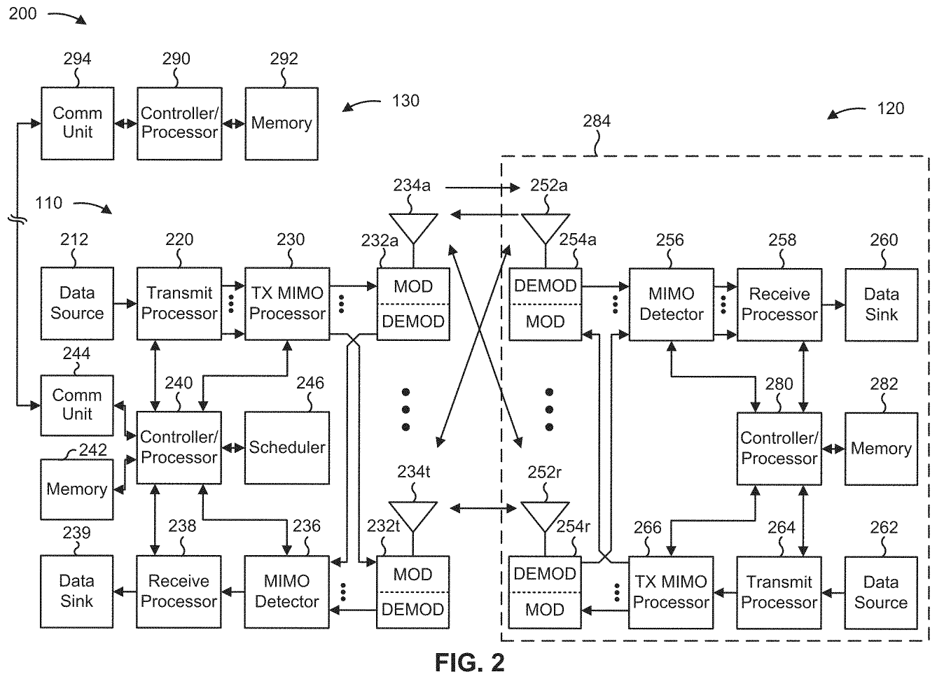

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

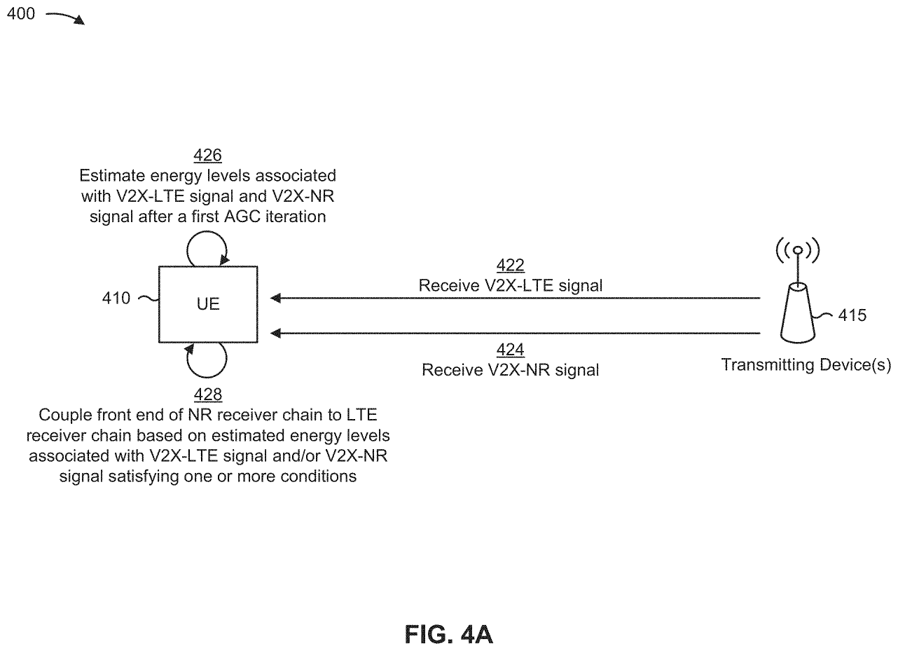

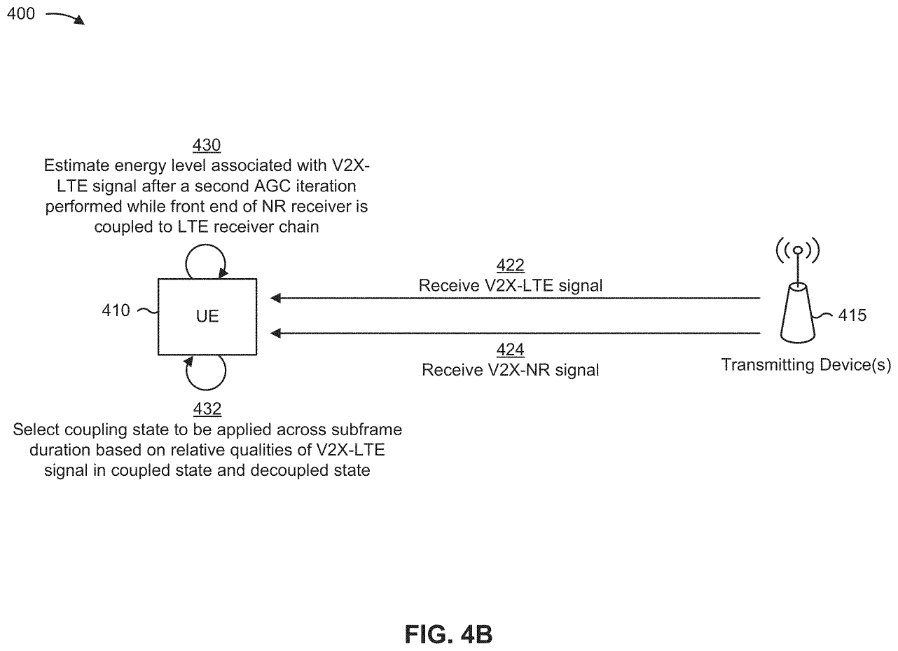

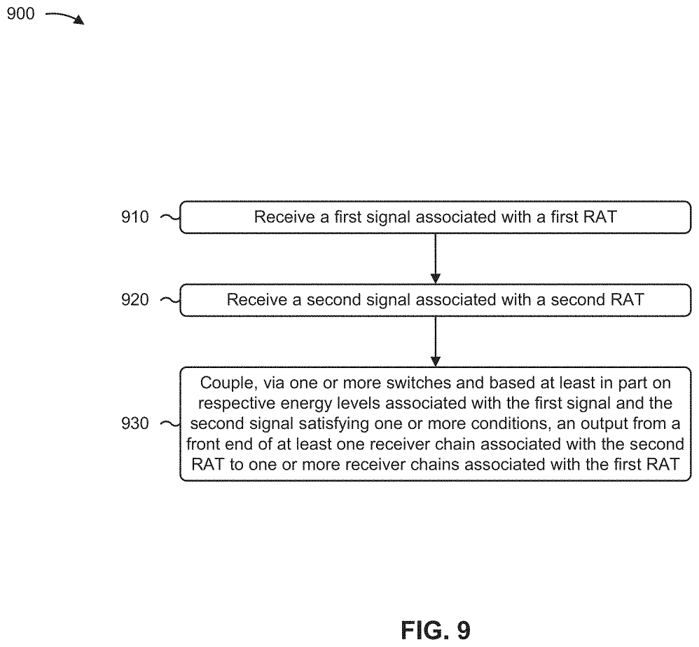

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4A-4B, FIGS. 5A-5C, FIGS. 6A-6C, FIG. 7, FIGS. 8A-8B, and/or FIG. 9.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4A-4B, FIGS. 5A-5C, FIGS. 6A-6C, FIG. 7, FIGS. 8A-8B, and/or FIG. 9.

Controller/processor 240 of base station 110, controller/processor 280 of UE 120, and/or any other component(s) of FIG. 2 may perform one or more techniques associated with concurrent multi-RAT reception based on switched diversity, as described in more detail elsewhere herein. For example, controller/processor 240 of base station 110, controller/processor 280 of UE 120, and/or any other component(s) of FIG. 2 may perform or direct operations of, for example, process 900 of FIG. 9 and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 900 of FIG. 9 and/or other processes as described herein. In some aspects, executing instructions may include running the instructions, converting the instructions, compiling the instructions, interpreting the instructions, and/or the like

In some aspects, UE 120 may include means for receiving a first signal associated with a first RAT, means for receiving a second signal associated with a second RAT, means for coupling, based at least in part on respective energy levels associated with the first signal and the second signal satisfying one or more conditions, an output from a front end of at least one receiver chain associated with the second RAT to one or more receiver chains associated with the first RAT. In some aspects, such means may include one or more components of UE 120 described in connection with FIG. 2, such as antenna 252, DEMOD 254, MIMO detector 256, receive processor 258, controller/processor 280, memory 282, transmit processor 264, TX MIMO processor 266, MOD 254, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with respect to FIG. 2.

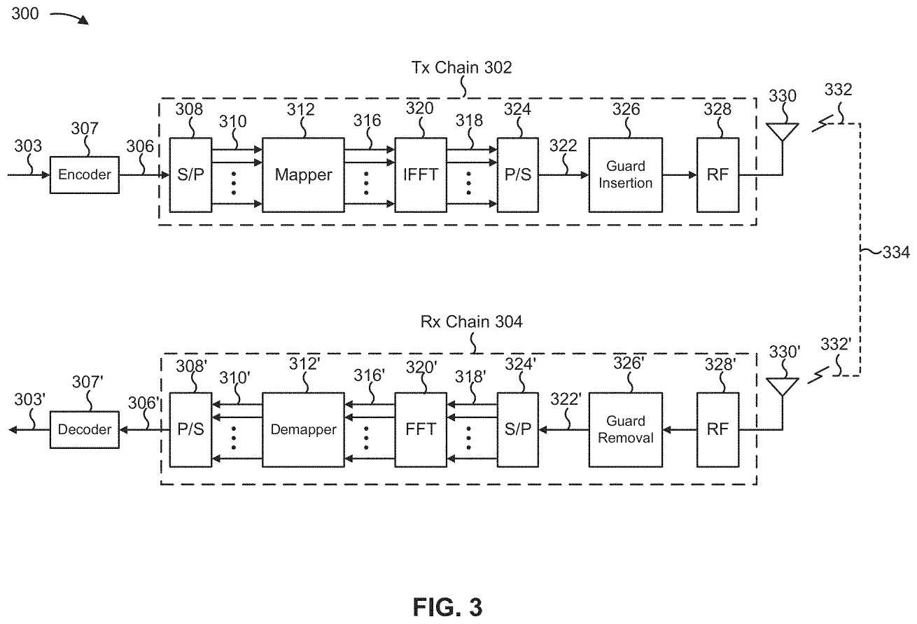

FIG. 3 is a diagram illustrating an example 300 of a transmit (Tx) chain 302 and a receive (Rx) chain 304 of a UE 120, in accordance with various aspects of the present disclosure. In some aspects, one or more components of Tx chain 302 may be implemented in transmit processor 264, TX MIMO processor 266, MOD/DEMOD 254, controller/processor 280, and/or the like, as described above in connection with FIG. 2. In some aspects, Tx chain 302 may be implemented in UE 120 for transmitting data 306 (e.g., uplink data, an uplink reference signal, uplink control information, and/or the like) to base station 110 on an uplink channel.

An encoder 307 may alter a signal (e.g., a bitstream) 303 into data 306. Data 306 to be transmitted is provided from encoder 307 as input to a serial-to-parallel (S/P) converter 308. In some aspects, S/P converter 308 may split the transmission data into N parallel data streams 310.

The N parallel data streams 310 may then be provided as input to a mapper 312. Mapper 312 may map the N parallel data streams 310 onto N constellation points. The mapping may be done using a modulation constellation, such as binary phase-shift keying (BPSK), quadrature phase-shift keying (QPSK), 8 phase-shift keying (8 PSK), quadrature amplitude modulation (QAM), etc. Thus, mapper 312 may output N parallel symbol streams 316, each symbol stream 316 corresponding to one of N orthogonal subcarriers of an inverse fast Fourier transform (IFFT) component 320. These N parallel symbol streams 316 are represented in the frequency domain and may be converted into N parallel time domain sample streams 318 by IFFT component 320.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of guard insertion component 326 may then be upconverted to a desired transmit frequency band by a radio frequency (RF) front end 328. An antenna 330 may then transmit the resulting signal 332.

In some aspects, Rx chain 304 may utilize OFDM/OFDMA. In some aspects, one or more components of Rx chain 304 may be implemented in receive processor 258, MIMO detector 256, MOD/DEMOD 254, controller/processor 280, and/or the like, as described above in connection with FIG. 2. In some aspects, Rx chain 304 may be implemented in UE 120 for receiving data 306 (e.g., downlink data, a downlink reference signal, downlink control information, and/or the like) from base station 110 on a downlink channel.

A transmitted signal 332 is shown traveling over a wireless channel 334 from Tx chain 302 to Rx chain 304. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by guard insertion component 326.

The output of guard removal component 326′ may be provided to an S/P converter 324′. The output may include an OFDM/OFDMA symbol stream 322′, and S/P converter 324′ may divide the OFDM/OFDMA symbol stream 322′ into N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by mapper 312, thereby outputting N parallel data streams 310′. A P/S converter 308′ may combine the N parallel data streams 310′ into a single data stream 306′. Ideally, data stream 306′ corresponds to data 306 that was provided as input to Tx chain 302. Data stream 306′ may be decoded into a decoded data stream 303′ by decoder 307′.

The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally, or alternatively, a set of components (e.g., one or more components) shown in FIG. 3 may perform one or more functions described as being performed by another set of components shown in FIG. 3.

Vehicle-to-everything (V2X) communication is an umbrella term that generally refers to technologies that can be used to communicate information between a vehicle equipped with suitable communication capabilities and one or more other devices. For example, V2X communication may include vehicle-to-vehicle (V2V) communication technologies that allow vehicles to communicate with one another (e.g., to support safety systems with non-line-of-sight and latency-sensitive collision avoidance capabilities), vehicle-to-infrastructure (V2I) communication technologies that allow vehicles to communicate with external systems such as street lights, buildings, and/or the like, vehicle-to-pedestrian (V2P) communication technologies that allow vehicles to communicate with smartphones, connected wearable devices, and/or the like, vehicle-to-network (V2N) communication technologies that allow vehicles to communicate with cellular networks, and/or the like.

In some cases, V2X communication may be supported on cellular networks. For example, in 3GPP Release 14, cellular V2X (C-V2X) was initially defined with LTE as an underlying radio access technology (RAT), and in 3GPP Release 15, C-V2X functionality was expanded to provide support for communication using NR as an enabling RAT. Accordingly, in some cases, V2X communications over LTE may operate concurrently with V2X communications over NR. However, simultaneous or concurrent reception of LTE and NR V2X signals presents various challenges. For example, to concurrently receive a V2X-LTE signal and a V2X-NR signal, a V2X receiver may need to operate at a large dynamic range from about −100 decibel milli-watts (dBm) to about −22 dBm, and reception performance may generally depend on a ratio between the V2X-LTE signal and the V2X-NR signal and/or receiver chain selectivity up to an analog-to-digital converter (ADC).

In particular, because channel conditions in a V2X communication system can vary widely and change quickly due to the high mobility of vehicles and UEs, large variations in vehicle traffic at different times of day and in different locations, variation in topographies that the vehicles may traverse, and/or the like, a receiving device that may be attempting to receive a V2X signal may typically perform automatic gain control (AGC) training, which refers to mechanisms to tune or otherwise configure a receive component (e.g., a radio frequency front end (RFFE) and/or another receive component) to match a received signal power and thereby prevent the receive component from becoming saturated. In cases where the receiving device is concurrently receiving a V2X-LTE signal and a V2X-NR signal, the V2X-LTE signal and the V2X-NR signal may appear as a composite signal, and the AGC typically operates on the composite signal at an input to the ADC. Accordingly, in cases where a relatively weak V2X-LTE signal (e.g., on the order of −100 dBm to −80 dBm) is received in the presence of a relatively strong V2X-NR signal (e.g., on the order of −50 dBm to −22 dBm), the V2X-NR signal may act as a jammer that pushes the V2X-LTE signal below or close to thermal noise by the AGC. Furthermore, because there is typically no selectivity (e.g., RF filtering to differentiate the V2X-LTE signal from the V2X-NR signal) in the receiver chain up to an output from a mixer that feeds into a low-pass filter (LPF), a strong V2X-NR signal may compress the V2X-LTE receiver chain and cause saturation at the output from the mixer and/or at other components in the receiver chain (e.g., a transimpedance amplifier).

Accordingly, in a V2X wireless communication system that supports concurrent operation via multiple RATs, including an LTE RAT and an NR RAT, there are various conditions in which the concurrent multi-RAT operation may cause degraded performance of V2X communication based on the LTE RAT relative to standalone V2X-LTE communication (e.g., when a relatively weak V2X-LTE signal is received in the presence of a relatively strong V2X-NR signal such that a ratio of the V2X-LTE signal to the V2X-NR signal fails to satisfy a threshold, or when the V2X-LTE signal has a low signal-to-noise ratio (SNR)). However, for various reasons, V2X communication based on the LTE RAT may need to be protected against degraded performance. For example, because LTE networks are currently more widely deployed than NR networks, V2X-LTE may be used as a primary RAT for communicating safety alerts and other high-priority information to and/or among vehicular UEs (e.g., information related to traffic signal phase timing, locations of nearby vehicles, pedestrians, bicyclists, and/or the like, information related to inclement weather, nearby accidents and road conditions, dangerous activities of nearby vehicles, and/or the like).

Some aspects described herein provide techniques and apparatuses for enabling concurrent multi-RAT reception based on switched diversity. For example, in a V2X wireless communication system that supports concurrent V2X operation via an LTE RAT and an NR RAT, a UE may have a receiver subsystem that includes one or more standalone or independent receiver chains that are dedicated to communication via the NR RAT and one or more receiver chains that support communication via the LTE RAT. In some aspects, the one or more receiver chains that support communication via the LTE RAT may be independent receiver chains that are dedicated to communication via the LTE RAT, or the one or more receiver chains that support communication via the LTE RAT may include one or more LTE receive paths that share one or more antennas and an RFFE with one or more NR receive paths. In some aspects, to handle situations in which concurrent multi-RAT operation may cause degraded performance of V2X communication based on the LTE RAT, an output of a front end from the one or more standalone or independent receiver chains that are dedicated to communication via the NR RAT may be switched or otherwise coupled to the one or more receiver chains that support communication via the LTE RAT when respective energy levels associated with a V2X-LTE signal and a V2X-NR signal satisfy one or more conditions (e.g., when a strong V2X-NR signal may cause saturation in the one or more receiver chains that support communication via the LTE RAT).

In this way, when the UE detects potentially degraded performance via the LTE RAT, the UE may inject the output of the front end of the one or more receiver chains that are dedicated to communication via the NR RAT into the one or more receiver chains that support communication via the LTE RAT, which may improve the performance of the LTE RAT. For example, the front end of the receiver chain(s) dedicated to the NR RAT may generally include one or more antennas, external LNAs (eLNAs), and/or the like that are densely integrated and designed in accordance with advanced antenna techniques, antenna tuning, and/or the like to support millimeter wave (mmW) communication, multiple input multiple output (MIMO) communication on a downlink, receive beamforming, and/or the like. Accordingly, in some cases, the output of the front end of the receiver chain(s) dedicated to the NR RAT may be stronger or more robust than the output of the front end of the receiver chain(s) that support the LTE RAT, whereby injecting the output of the front end of the NR receiver chain(s) into the LTE receiver chain(s) may result in a performance gain for the LTE RAT.

FIGS. 4A-4B are diagrams illustrating an example implementation 400 of concurrent reception of multiple RATs based on switched diversity, in accordance with various aspects of the present disclosure.

As shown in FIGS. 4A-4B, a UE 410 may communicate with one or more transmitting devices 415 (e.g., another UE, an infrastructure device, a base station, a transmit receive point, and/or the like) according to one or more V2X protocols. For example, in some aspects, the one or more V2X protocols may operate in a high frequency band (e.g., the 5.9 GHz band), which may be subdivided into different frequency sub-bands that are used to support communication via different RATs (e.g., a first sub-band to support V2X communication via an LTE RAT, sometimes referred to as Basic C-V2X and/or the like, may include frequencies from 5.905 GHz to 5.925 GHz, and a second sub-band to support communication via an NR RAT, sometimes referred to as Advanced C-V2X and/or the like, may include frequencies from 5.865 GHz to 5.905 GHz). In some aspects, the UE 410 may correspond to one or more UEs described elsewhere herein, such as UE 120 and/or the like. Furthermore, in some aspects, the UE 410 may be integrated into a vehicle, may be located in or on a vehicle, and/or the like, and the vehicle may be an autonomous vehicle, a semi-autonomous vehicle, a non-autonomous vehicle, and/or the like. Additionally, or alternatively, in some aspects, the UE 410 may not be associated with a vehicle. For example, the UE 410 may be an infrastructure device (e.g., a traffic infrastructure device, such as a traffic signal, a lane signal, a sensor, a traffic controller system, and/or the like), a pedestrian device (e.g., a smartphone, a wearable device, and/or the like), and/or another suitable V2X-enabled device.

As further shown in FIG. 4A, and by reference numbers 422 and 424, the UE 410 may receive a V2X-LTE signal and a V2X-NR signal from the one or more transmitting devices 415. For example, the V2X-LTE signal and the V2X-NR signal may include V2X data related to a vehicle-to-vehicle (V2V) protocol, a vehicle-to-infrastructure (V2I) protocol, a vehicle-to-pedestrian (V2P) protocol, a vehicle-to-network (V2N) protocol, and/or the like. For example, the V2X data may include a basic safety message (BSM), a traffic information message (TIM), a signal phase and time (SPAT) message, a MAP message to convey geographic road information, a cooperative awareness message (CAM), a distributed environment notification message (DENM), an in-vehicle information (IVI) message, and/or the like. In some aspects, the V2X data may include data relevant to operation of a vehicle associated with the UE 410. Furthermore, in some aspects, the V2X-LTE signal may be used to carry information related to safety alerts and/or other high-priority information.

As further shown in FIG. 4A, and by reference number 426, the UE 410 may estimate energy levels associated with the V2X-LTE signal and the V2X-NR signal after a first AGC iteration. For example, the first AGC iteration may be a fast AGC (F-AGC) operation performed during a first symbol in a subframe, which typically has a duration of about 71 microseconds (μs), and the first AGC iteration may be performed in about 28 μs or less (e.g., about 3 μs for a V2X channel propagation delay, about 15 μs for a wideband energy estimation (WBEE) accumulation time, and about 10 μs or less for an F-AGC gain setting and convergence time). Accordingly, in some aspects, the first AGC iteration may be completed in less than half the symbol time, which may permit a second AGC iteration to be performed and completed within a single subframe symbol. In some aspects, as described herein, the UE 410 may utilize the ability to perform two AGC iterations within the single subframe to switch a coupling among antennas, front end components, receiver chain paths, and/or the like when relative strengths of the V2X-LTE signal and the V2X-NR signal may degrade performance for the V2X-LTE signal.

More particularly, in some aspects, the UE 410 may include a receiver subsystem including various antennas, front end components, receiver chain paths, and/or the like that enable concurrent and/or simultaneous reception of the V2X-LTE signal and the V2X-NR signal. For example, in some aspects, the receiver subsystem may include an independent receiver chain dedicated to processing V2X-NR signals and one or more shared receiver chains in which one or more V2X-LTE receive paths and one or more V2X-NR receive paths share one or more antennas and one or more front end components (e.g., an eLNA). Additionally, or alternatively, the receiver subsystem may include multiple independent receiver chains, each of which may have independent antennas, front end components, and receive paths that are dedicated to processing either V2X-LTE signals or V2X-NR signals.

In some aspects, the receiver subsystem associated with the UE 410 may further include or otherwise be associated with one or more components that can estimate the energy levels associated with the V2X-LTE signal and the V2X-NR signal. For example, as mentioned above, the UE 410 may include multiple antennas that may receive the V2X-LTE signal and the V2X-NR signal simultaneously or substantially concurrently, whereby the V2X-LTE signal and the V2X-NR signal may be received at the multiple antennas as a composite signal level. Each receiver chain in the receiver subsystem may have a front end that includes an eLNA arranged to receive the composite signal from the corresponding antenna, which may be set to a relatively low gain. After the composite signal is processed by the front end, an output from the front end may be provided to a corresponding receive path that includes an internal LNA (iLNA), a mixer, a low-pass filter (LPF), and an analog-to-digital converter (ADC), and the first AGC iteration may operate on the composite signal at an input to the ADC.

Accordingly, in some aspects, the composite signal may experience an overall gain (G) in the receiver chain from the antenna to the ADC input, and the V2X-LTE and the V2X-NR signals may experience respective selective gains (Gₓ(f) and G_{y}(f)) from the mixer output to the LPF output. In some aspects, the overall gain (G), the selective gains (Gₓ(f) and G_{y}(f)) may be used to determine a WBEE that corresponds to a measurement of the energy level (or, in some aspects, a power level) of the received V2X signals after conversion by the ADC. Furthermore, in some aspects, an RF detector may be arranged to determine a signal level associated with the composite signal at the antenna port, and the signal level associated with the composite signal can be used in combination with the WBEE-LTE and WBEE-NR measurements to estimate the respective energy levels associated with the V2X-LTE signal and the V2X-NR signal (e.g., according to a signal-to-noise ratio (SNR), a received signal strength indication (RSSI), and/or the like). Additionally, or alternatively, in some aspects, narrowband (NB) energy estimation (NBEE) may be performed for each carrier to measure in-band power for the V2X-LTE signal and/or the V2X-NR signal, and respective SNRs, RSSIs (e.g., per frequency slice), and/or the like for the V2X-LTE signal and the V2X-NR signal may be estimated based at least in part on the in-band power measurements. For example, the NBEE may correspond to a measurement of the energy level (or, in some aspects, the power level) of a narrowband signal after narrowband filtering, which may be determined at an input or an output of one or more digital gain components for a respective carrier. In this way, the UE 410 may identify cases in which relative strengths of the V2X-LTE signal and the V2X-NR signal may potentially degrade performance for the V2X-LTE signal that may be used to carry safety alerts or other high-priority information.

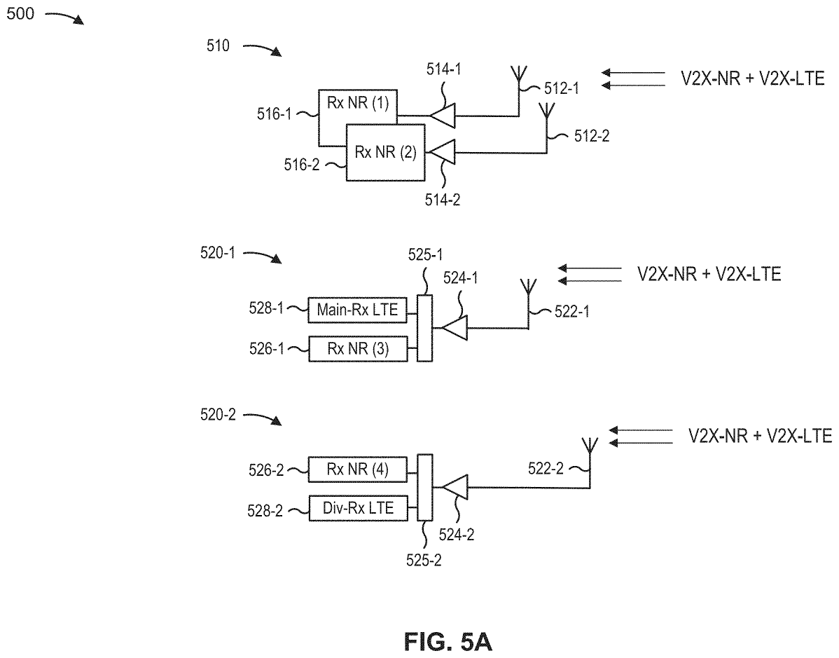

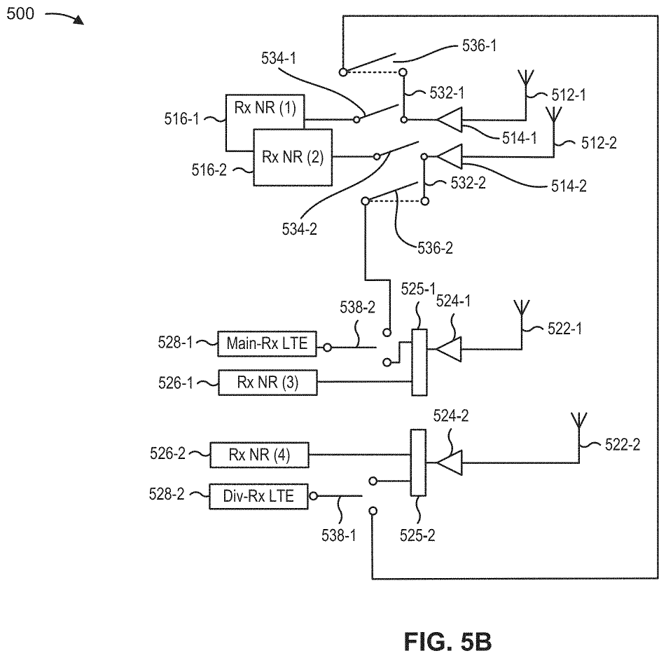

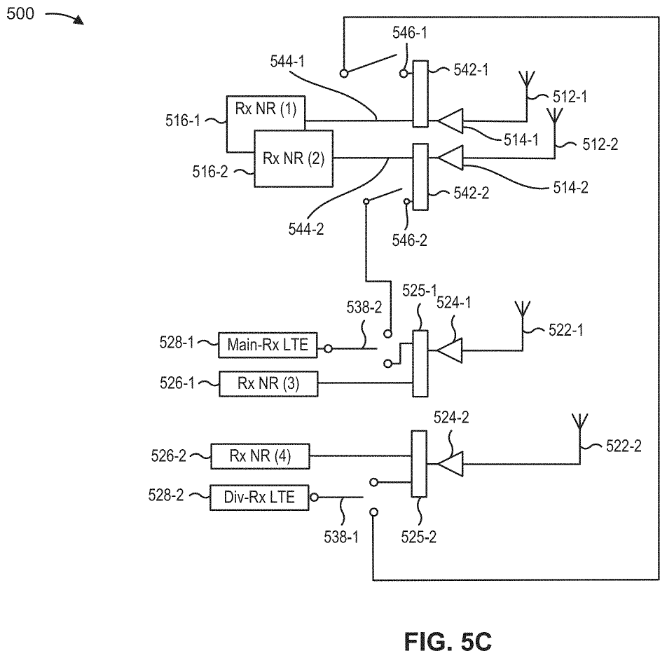

As further shown in FIG. 4A, and by reference number 428, the UE 410 may couple an output from a front end of one or more receiver chains that are dedicated to processing V2X-NR signals to one or more receiver chains used to process V2X-LTE signals based at least in part on the estimated energy levels associated with the V2X-LTE signal and/or the V2X-NR signal satisfying one or more conditions. In some aspects, the one or more conditions may generally be defined to enhance performance or prevent degraded performance for the V2X-LTE signal (e.g., due to the possibility that the V2X-LTE signal carries important safety information). For example, the UE 410 may determine that the one or more conditions are satisfied when the energy level (e.g., the SNR, RSSI, and/or the like) of the V2X-LTE signal fails to satisfy a first threshold and the energy level of the V2X-NR signal satisfies a second threshold, which may be the same as or different from the first threshold. In this way, the UE 410 may identify cases in which a difference in relative strengths for the V2X-LTE signal and the V2X-NR signal is large enough to potentially degrade performance of the V2X-LTE signal. In some aspects, various implementations for coupling the output from the front end of the receiver chain(s) dedicated to processing V2X-NR signals to one or more receiver chains used to process V2X-LTE signals are described in further detail below with reference to FIGS. 5A-5C, FIGS. 6A-6C, and FIG. 7.

As shown in FIG. 4B, and by reference number 430, the UE 410 may perform a second AGC iteration while the output from the front end of the NR receiver chain(s) is coupled to the LTE receiver chain(s) and the UE 410 may estimate the respective energy levels associated with the V2X-LTE signal after performing the second AGC iteration. In this case, the second AGC iteration may be completed in about 25 μs or less (e.g., about 15 μs for a WBEE accumulation time, and about 10 μs or less for an F-AGC gain setting and convergence time). Accordingly, as the first AGC iteration may be completed in about 28 μs or less and the second AGC iteration may be completed in about 25 μs or less, the two AGC iterations may have a convergence time of about 53 μs, which is 18 μs less than the 71 μs symbol time.

As further shown in FIG. 4B, and by reference number 432, the UE 410 may select a coupling state to be applied across the remaining symbols in the subframe duration based at least in part on the relative qualities (e.g., SNRs, RSSIs, and/or the like) of the V2X-LTE signal in the coupled state (e.g., after the second AGC iteration) and the decoupled state (e.g., after the first AGC iteration). For example, if the estimated energy level for the V2X-LTE signal fails to satisfy the first threshold after the first AGC iteration and satisfies the first threshold after the second AGC iteration, the UE 410 may operate the receiver subsystem with the output from the front end of the NR receiver chain(s) coupled to the LTE receiver chain(s) across the remaining symbols in the subframe. Additionally, or alternatively, the receiver subsystem may be operated in the coupled state (with the output from the front end of the NR receiver chain(s) coupled to the LTE receiver chain(s)) if the estimated energy level for the V2X-LTE signal after the second AGC iteration is greater than the estimated energy level for the V2X-LTE signal after the first AGC iteration (e.g., the V2X-LTE signal exhibits an improved SNR, RSSI, and/or the like in the coupled state), if the V2X-LTE signal has an SNR, RSSI, and/or the like that allows demodulation after the second AGC iteration, and/or the like. Otherwise, if the estimated energy level for the V2X-LTE signal still fails to satisfy the first threshold after the second AGC iteration or otherwise fails to exhibit improved performance in the coupled state, the UE 410 may switch the receiver subsystem back to the original state(s) for the remaining symbols in the subframe.

As indicated above, FIGS. 4A-4B are provided as an example. Other examples may differ from what is described with respect to FIGS. 4A-4B.

FIGS. 5A-5C are diagrams illustrating an example implementation 500 of concurrent multi-RAT reception based on switched diversity where a UE has one or more antennas and one or more receiver chains that are shared among different RATs, in accordance with various aspects of the present disclosure.

For example, as shown in FIG. 5A, the UE (e.g., UE 120, UE 410, and/or the like) may include an independent NR receiver chain 510 that includes a front end with a pair of antennas 512-1, 512-2 coupled to a respective pair of eLNAs 514-1, 514-2. As further shown in FIG. 5A, the independent NR receiver chain 510 includes a pair of NR receive paths 516-1, 516-2 that are coupled to respective outputs from the pair of eLNAs 514-1, 514-2. Furthermore, the UE may include a pair of shared receiver chains 520-1, 520-2, each of which include a front end with one antenna 522 and a corresponding eLNA 524 that are shared among an NR receive path 526 and an LTE receive path 528 (e.g., a main LTE receive path 528-1 and a diversity LTE receive path 528-2). For example, as shown in FIG. 5A, the shared receiver chains 520-1, 520-2 each include a splitter device 525 coupled to the respective output from the corresponding eLNA 524. Accordingly, the output from the eLNAs 524-1, 524-2 may be received by the corresponding splitter devices 525-1, 525-2, which may divide a composite signal based on a V2X-LTE signal and a V2X-NR signal received at the corresponding antennas 522 among the corresponding NR and LTE receive paths 526, 528. In some aspects, the configuration shown in FIG. 5A may generally correspond to the decoupled state of the receiver subsystem mentioned elsewhere herein.

As shown in FIG. 5B, the receiver subsystem may include various switches that are arranged to permit an output from the eLNAs 514 in the independent receiver chain 510 to be coupled to the LTE receive paths 528. For example, as shown in FIG. 5B, each eLNA 514 may generate an output 532 that is coupled to a first single pole single throw (SPST) switch 534 that may be positioned in a closed state to couple the output 532 from the eLNA 514 to the NR receive path 516 or alternatively positioned in an open state to decouple the output 532 from the corresponding NR receive path 516. Furthermore, the output 532 from each eLNA 514 may be coupled to a second SPST switch 536 that may have a state that is opposite from the first SPST switch 534. For example, the second SPST switch 536 may be positioned in a closed state when the first SPST switch 534 is positioned in the open state in order to couple the output 532 from the eLNA 514 to an LTE receive path 528. Alternatively, in some aspects, the second SPST switch 536 may be positioned in an open state when the first SPST switch 534 is positioned in a closed state to decouple the output 532 from the corresponding LTE receive path 528.

As further shown in FIG. 5B, each of the LTE receive paths 528 may include a single pole double throw (SPDT) switch 538 that can be selectively coupled to either the output from the corresponding eLNA 524 and splitter device 525 or to the output 532 from the corresponding eLNA 514 in the independent NR receiver chain 510. For example, in some aspects, the SPDT switch 538 may be coupled to the output from the corresponding eLNA 524 and splitter device 525 during a first AGC iteration and switched to couple to the output 532 from the corresponding eLNA 514 in the independent NR receiver chain 510 based at least in part on energy levels associated with a V2X-LTE and V2X-NR signal satisfying one or more conditions (e.g., the V2X-LTE signal having a low SNR, RSSI, and/or the like in the presence of a strong V2X-NR signal).

Referring to FIG. 5C, the receiver subsystem may alternatively be configured to permit the output from the eLNAs 514 to be concurrently coupled to the LTE receive paths 528 and the corresponding NR receive paths 516 in the independent receiver chain 510. For example, as shown in FIG. 5C, each eLNA 514 may be coupled to a respective splitter device 542 that has a first port 544 coupled to the corresponding NR receive path 516 and a second port 546 that couples to the corresponding LTE receive path 528 via the SPST switch 536 and the SPDT switch 538. In this way, the NR receive paths 516 can continue to process the V2X-NR signal received at the corresponding antennas 512 while part of the composite signal based on the V2X-LTE signal and the V2X-NR signal is diverted to the LTE receive paths 528. Furthermore, in some aspects, the second port 546 that couples to the corresponding LTE receive path 528 may be terminated with one or more resistive devices (e.g., a 50Ω resistor) in cases where the output from the eLNA 514 is not switched or otherwise coupled to the LTE receive paths 528 (e.g., when the SPST switch 536 is in an open state, when the SPDT switch 538 is coupled to the corresponding splitter device 525, and/or the like).

As indicated above, FIGS. 5A-5C are provided as an example. Other examples may differ from what is described with respect to FIGS. 5A-5C. For example, although the example implementation(s) 500 are shown in FIGS. 5A-5C as using one or more SPSTs, SPDTs, and/or the like to switch the front-end of a receiver for a first RAT (e.g., an NR RAT) into a receiver for a second RAT (e.g., an LTE RAT), any suitable switching mechanism can be employed to couple and/or decouple the front-end of a receiver for one RAT into a receiver for another RAT (or vice versa).

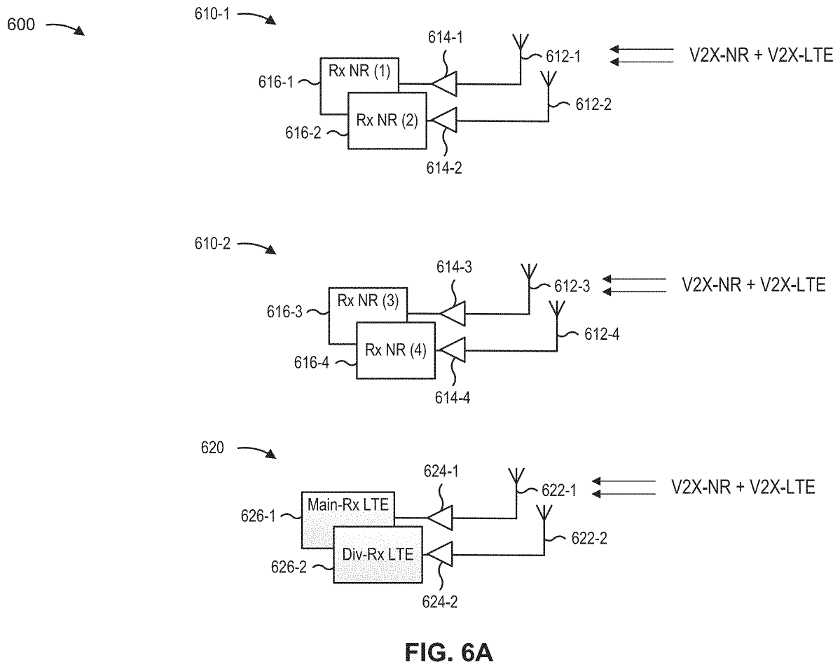

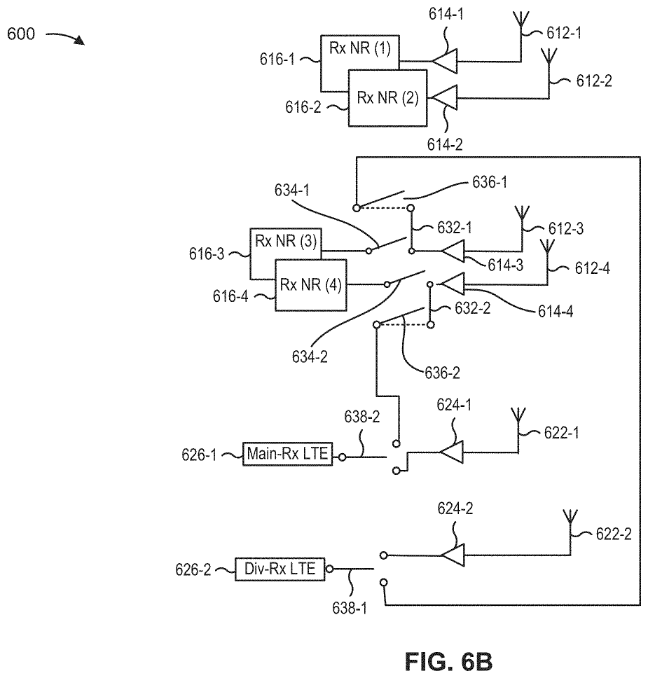

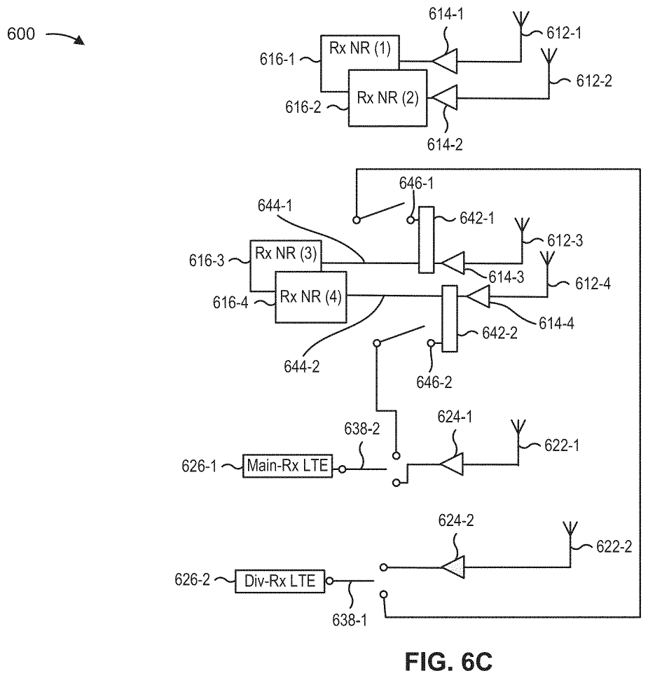

FIGS. 6A-6C are diagrams illustrating an example implementation 600 of concurrent multi-RAT reception based on switched diversity where a UE has independent antennas and independent receiver chains for multiple different RATs, in accordance with various aspects of the present disclosure.

For example, as shown in FIG. 6A, the UE (e.g., UE 120, UE 410, and/or the like) may include a pair of independent NR receiver chains 610, each of which includes a front end with a pair of antennas 612 coupled to a respective pair of eLNAs 614. As further shown in FIG. 6A, the independent NR receiver chains 610 each includes a pair of NR receive paths 616 that are coupled to respective outputs from the pair of eLNAs 614. Furthermore, the UE may include an independent LTE receiver chain 620 that includes a front end with a pair of antennas 622 and a corresponding pair of eLNAs 624 that are coupled to respective LTE receive paths 626 (e.g., a main LTE receive path 626-1 and a diversity LTE receive path 626-2). In some aspects, the configuration shown in FIG. 6A may generally correspond to the decoupled state of the receiver subsystem mentioned elsewhere herein.

As shown in FIG. 6B, the receiver subsystem may include various switches that are arranged to permit an output from the eLNAs 614 in one of the independent NR receiver chains 610 to be coupled to the LTE receive paths 626. For example, as shown in FIG. 6B, each eLNA 614 may generate an output 632 that is coupled to a first SPST switch 634 that may be positioned in a closed state to couple the output 632 from the eLNA 614 to the NR receive path 616 or alternatively positioned in an open state to decouple the output 632 from the corresponding NR receive path 616. Furthermore, the output 632 from each eLNA 614 may be coupled to a second SPST switch 636 that may have a state that is opposite from the first SPST switch 634. For example, the second SPST switch 636 may be positioned in a closed state when the first SPST switch 634 is positioned in the open state in order to couple the output 632 from the eLNA 614 to an LTE receive path 626. Alternatively, in some aspects, the second SPST switch 636 may be positioned in an open state when the first SPST switch 634 is positioned in a closed state to decouple the output 632 from the corresponding LTE receive path 626.

As further shown in FIG. 6B, each of the LTE receive paths 626 may include an SPDT switch 638 that can be selectively coupled to either the output from the corresponding eLNA 624 or to the output 632 from the corresponding eLNA 614 in the independent NR receiver chain 610. For example, in some aspects, the SPDT switch 638 may be coupled to the output from the corresponding eLNA 624 during a first AGC iteration and switched to couple to the output 632 from the corresponding eLNA 614 in the independent NR receiver chain 610 based at least in part on energy levels associated with a V2X-LTE and V2X-NR signal satisfying one or more conditions (e.g., the V2X-LTE signal having a low SNR, RSSI, and/or the like in the presence of a strong V2X-NR signal).

Referring to FIG. 6C, the receiver subsystem may alternatively be configured to permit the output from the eLNAs 614 to be concurrently coupled to the LTE receive paths 626 and the corresponding NR receive paths 616. For example, as shown in FIG. 6C, each eLNA 614 may be coupled to a respective splitter device 642 that has a first port 644 coupled to the corresponding NR receive path 616 and a second port 646 that couples to the corresponding LTE receive path 626 via the SPST switch 636 and the SPDT switch 638. In this way, the NR receive paths 616 can continue to process the V2X-NR signal received at the corresponding antennas 612 while part of the composite signal based on the V2X-LTE signal and the V2X-NR signal is diverted to the LTE receive paths 626. Furthermore, in some aspects, the second port 646 that couples to the corresponding LTE receive path 628 may be terminated with one or more resistive devices (e.g., a 50Ω resistor) in cases where the output from the eLNA 614 is not switched or otherwise coupled to the LTE receive paths 626 (e.g., when the SPST switch 636 is in an open state, when the SPDT switch 638 is coupled to the corresponding eLNA 624, and/or the like).

As indicated above, FIGS. 6A-6C are provided as an example. Other examples may differ from what is described with respect to FIGS. 6A-6C. For example, although the example implementation(s) 600 are shown in FIGS. 6A-6C as using one or more SPSTs, SPDTs, and/or the like to switch the front-end of a receiver for a first RAT (e.g., an NR RAT) into a receiver for a second RAT (e.g., an LTE RAT), any suitable switching mechanism can be employed to couple and/or decouple the front-end of a receiver for one RAT into a receiver for another RAT (or vice versa).

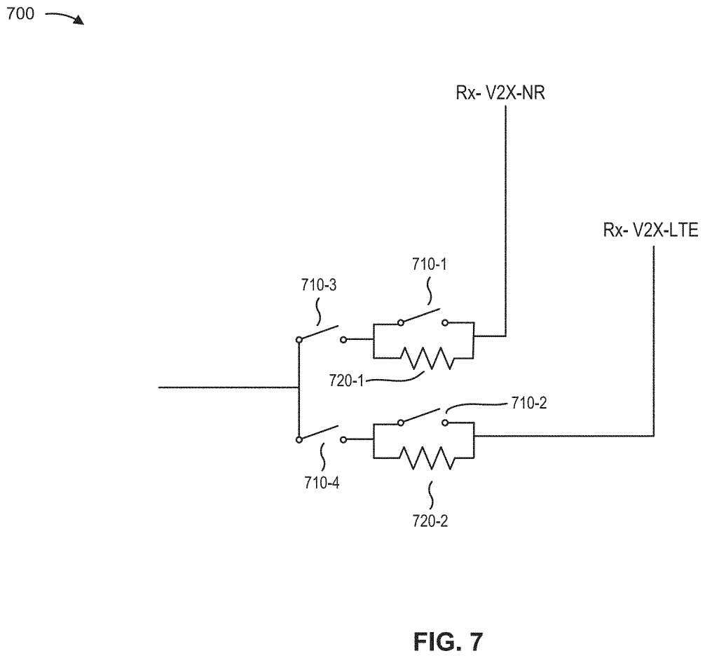

FIG. 7 is a diagram illustrating an example circuit 700 for enabling concurrent multi-RAT reception based on dynamic selection between a switched diversity mode and a combined diversity mode, in accordance with various aspects of the present disclosure. For example, in some aspects, V2X-LTE performance based on switched NR diversity as described herein can be further improved based at least in part on a modem associated with the UE determining that a V2X-LTE signal and a V2X-NR signal can be coherently combined. To handle such cases, the circuit 700 shown in FIG. 7 may enable the receiver subsystem to select between employing a combined diversity technique or a switched diversity technique as described elsewhere herein.

In particular, whereas various aspects described elsewhere herein employ an SPDT switch for switched diversity, the circuit 700 shown in FIG. 7 may employ various SPST switches 710 and resistive devices 720 to enable dynamic selection between a switched diversity mode and a combined diversity mode. For example, to operate in the switched diversity mode, the two SPST switches 710-1, 710-2 arranged in parallel with the resistive devices 720-1, 720-2 may be set to a closed state (e.g., turned on), which may result in the V2X-LTE and V2X-NR signals bypassing the resistive devices 720-1, 720-2. To operate in the combined diversity mode, the two SPST switches 710-1, 710-2 arranged in parallel with the resistive devices 720-1, 720-2 are opened (e.g., turned off), and either the SPST switch 710-3 or the SPST switch 710-4 is closed (turned on) while the other is open (turned off) to enable dynamic selection of either the V2X-LTE signal or the V2X-NR signal.

As indicated above, FIG. 7 is provided as an example. Other examples may differ from what is described with respect to FIG. 7. For example, although the example implementation 700 shown in FIG. 7 uses one or more SPSTs and resistive devices to enable dynamic selection between a switched diversity mode and a combined diversity mode, any suitable switching mechanism and/or circuitry can be employed.

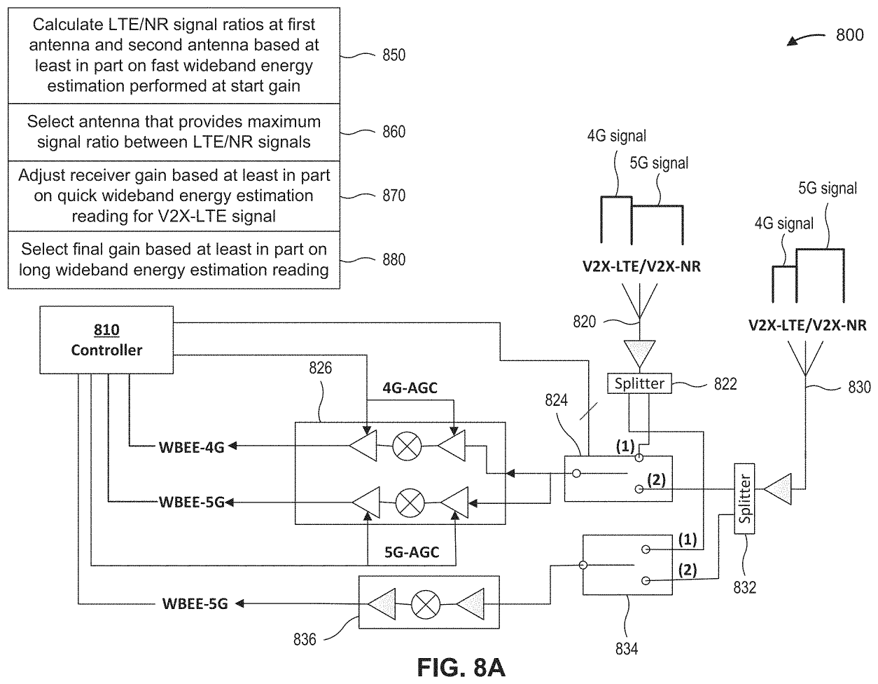

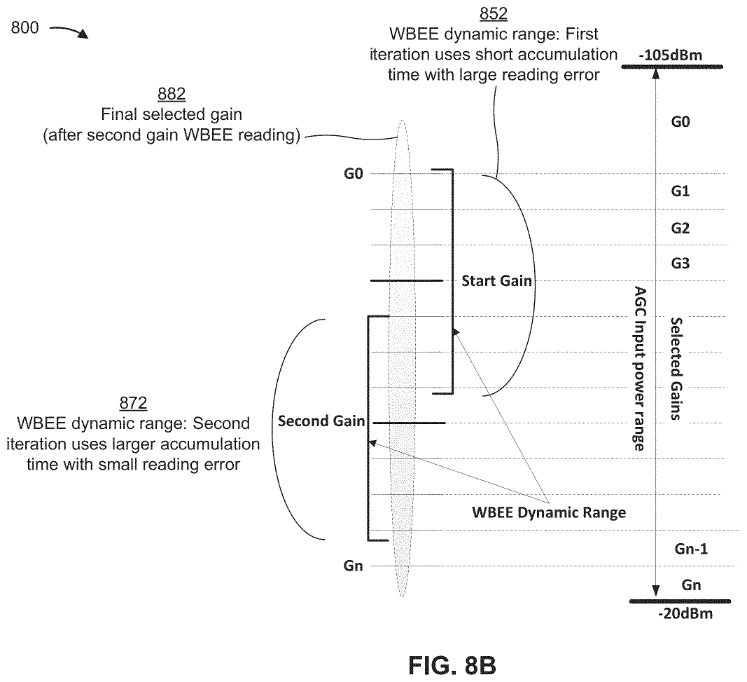

FIGS. 8A-8B are diagrams illustrating examples 800 associated with concurrent multi-RAT reception based on switched diversity, in accordance with various aspects of the present disclosure. As shown in FIGS. 8A-8B, example(s) may include an automatic gain control (AGC) architecture that can be implemented in a UE as described elsewhere herein and used to perform one or more AGC iterations to determine optimal gain values to protect a V2X-LTE signal against degraded performance that may be caused by a strong V2X-NR signal.

For example, V2X-LTE and V2X-NR channels are generally allocated adjacent frequency bands, bandwidth parts, and/or the like. For example, a V2X-LTE channel may be allocated 20 MHz in the 5.9 GHz frequency band (e.g., from 5.905 GHz to 5.925 GHz), and a V2X-NR channel may be allocated an adjacent 40 MHz in the 5.9 GHz frequency band (e.g., from 5.865 GHz to 5.905 GHz). In a standard configuration, a receiver may include four (4) NR antennas to enable MIMO operation and two (2) LTE antennas, including a main LTE antenna and a diversity LTE antenna. In some aspects, the NR and LTE antennas may be provided in separate hardware subsystems, or a common antenna may be used to receive NR and LTE signals, which are then split after passing through a low-noise amplifier (LNA). However, regardless of whether the antenna architecture uses separate antennas or a common antenna for the NR and LTE signals, in operation each antenna receives both the NR and the LTE signal. In cases where a weak V2X-LTE signal is received in the presence of a strong V2X-NR signal, the V2X-NR signal may degrade performance of the V2X-LTE signal that needs to be protected, to carry important safety information and/or the like. Accordingly, in some aspects, the AGC architecture shown in FIGS. 8A-8B may be used to determine one or more optimal gain values to protect the performance of the V2X-LTE signal.

For example, as described in further detail herein, the AGC architecture may include a first path in which a controller 810 is coupled to a first antenna 820 and a second antenna 830 that are each configured to receive a V2X-LTE signal and a V2X-NR signal. Furthermore, the first antenna 820 and the second antenna 830 may be coupled to respective splitter devices 822, 832 such that the combined V2X-LTE/V2X-NR signal received at each respective antenna 820, 830 is provided to separate input paths 824, 834. For example, each input path 824, 834 may include a switching mechanism to select the combined V2X-LTE/V2X-NR signal output from either the first splitter device 822 or the second splitter device 832, and each input path 824, 834 may output the selected signal to a respective wideband energy estimation (WBEE) component. For example, the first input path 824 may output the selected signal to a first WBEE component 826, and the second input path 834 may output the selected signal to a second WBEE component 836. Accordingly, the controller 810 may receive a 4G WBEE reading (e.g., a V2X-LTE WBEE reading) and a first 5G WBEE reading (e.g., a first V2X-NR WBEE reading) from the first WBEE component 826, and the controller 810 may further receive a second 5G WBEE reading (e.g., a second V2X-NR WBEE reading) from the second WBEE component 836. In some aspects, as described herein, the controller 810 may use the 4G and 5G WBEE readings to determine 4G and 5G AGC values to ensure optimal performance and protect the V2X-LTE signal against degraded performance that may be caused by a strong V2X-NR signal.

As shown in FIG. 8A, and by reference number 850, the controller may calculate LTE/NR signal ratios at the first antenna 820 and the second antenna 830 based at least in part on a fast WBEE performed at a starting gain value. For example, as described herein, the fast WBEE may be performed in connection with a fast AGC operation for an incoming signal received at the first antenna 820 and the second antenna 830, which generally includes a V2X-LTE signal and a V2X-NR signal. For example, in FIG. 8A, the first antenna 820 receives a V2X-LTE signal that is slightly stronger than a V2X-NR signal, and the second antenna 830 receives a V2X-NR signal that is stronger than a V2X-LTE signal. In general, in a V2X communication system, the AGC operations may be performed per subframe because different devices (e.g., vehicle UEs, pedestrian UEs, and/or the like) may be transmitting at different power levels, whereby input power may change significantly from one subframe to another (e.g., due to the high mobility of vehicles and UEs, variations in traffic at different times and in different locations, and/or the like). Accordingly, as described herein, the AGC operations may be performed in the first symbol of each subframe, and therefore need to be very fast in order to establish the appropriate gain value for the rest of the subframe.

For example, in some aspects, the fast AGC may be performed in a dynamic range from about −105 dBm to −20 dBm, although it will be appreciated that the dynamic range may span other gain values. In general, the fast AGC performed in a first AGC iteration may need to cover a discrete portion of the dynamic range (e.g., from GO to Gn in the example 800 shown in FIG. 8B). In cases where the V2X-LTE signal cannot be differentiated from the V2X-NR signal (e.g., where the energy of the V2X-NR signal is not suppressed enough after baseband filtering), the AGC operation may be used to select gain values that bias the V2X-LTE signal (e.g., to protect performance of the V2X-LTE signal that is used to carry important safety information) without the V2X-NR signal saturating an analog-to-digital converter. In other words, the V2X-NR signal can act as an interfering signal that may impact overall AGC performance. For example, the V2X-NR signal may cause the AGC to select a low gain when the V2X-NR signal is strong, which could cause the V2X-LTE signal to be lost or significantly degraded (e.g., associated with a reduced SNR or dropped below thermal noise).

Accordingly, as shown in FIG. 8B, and by reference number 852, a first (e.g., fast) AGC iteration may be performed at a start gain using a short accumulation time with a large WBEE reading error. As shown, the first AGC iteration does not cover the full dynamic range in which WBEE is performed. Accordingly, in some aspects, a second AGC iteration may be performed to handle cases where the incoming signal is outside (e.g., above) the WBEE dynamic range used in the first AGC iteration. For example, as described herein, the controller 810 may be configured to select the highest gain to protect operation of the V2X-LTE signal in two iterations, and the first iteration that is performed at the start gain may use a short accumulation (or convergence) time to ensure that the combined time for the two iterations satisfies timing requirements. Furthermore, although the short accumulation time used in the first iteration may result in a large WBEE reading error, the large WBEE reading error may not adversely affect performance, because the second iteration may use a larger accumulation time such that a WBEE reading used for final gain selection has a small WBEE reading error. In general, the short accumulation time used in the first iteration and the long accumulation time used in the second iteration may have a combined time that satisfies timing requirements (e.g., completing the AGC operation in the first symbol of a subframe).

Accordingly, in some aspects, the controller 810 may calculate a first ratio, between the V2X-LTE and V2X-NR signals received at the first antenna 820, and a second ratio between the V2X-LTE and V2X-NR signals received at the second antenna 830. In some aspects, as described herein, the controller 810 may calculate the first ratio and the second ratio while a gain is set to a start gain value that covers only a portion of the overall WBEE dynamic range (e.g., as shown in FIG. 8B).

For example, the controller 810 may couple the switching mechanisms provided in the input paths 824, 834 in a first state (shown as (1) in FIG. 8A), whereby both input paths 824, 834 receive an input signal from the splitter device 822 coupled to the first antenna 820. The first WBEE component 826 may include separate WBEE paths for the V2X-LTE signal and the V2X-NR signal, and may output WBEE readings for the V2X-LTE signal and the V2X-NR signal. For example, the first antenna 820 may be a shared 4G/5G (LTE/NR) antenna, and the second antenna 830 may be a dedicated 5G (NR) antenna. Accordingly, the second WBEE component 836 may include a WBEE path for the V2X-NR signal only, and may output a WBEE reading for only the V2X-NR signal to the controller 810. Accordingly, the controller 810 may calculate the first ratio between the V2X-LTE and V2X-NR signals as received at the first antenna 820 based at least in part on the WBEE readings output from the first WBEE component 826 and the second WBEE component 836.

In some aspects, the controller 810 may then couple the switching mechanisms provided in the input paths 824, 834 in a second state (shown as (2)), whereby both input paths 824, 834 receive an input signal from the splitter device 832 coupled to the second antenna 830. The first WBEE component 826 may similarly output WBEE readings for the V2X-LTE signal and the V2X-NR signal, and the second WBEE component 836 may output a WBEE reading for the V2X-NR signal to the controller 810. Accordingly, the controller 810 may calculate the second ratio between the V2X-LTE and V2X-NR signals as-received at the second antenna 830 based at least in part on the WBEE readings output from the WBEE components 826, 836.

As further shown in FIG. 8A, and by reference number 860, the controller 810 may select an antenna (either antenna 820 or antenna 830) that provides a maximum signal ratio between the V2X-LTE and V2X-NR signals. In particular, as described herein, the AGC operations protect the V2X-LTE signal against performance degradation that may occur in the presence of a strong V2X-NR signal, whereby the antenna that provides the maximum signal ratio between the V2X-LTE and V2X-NR signals may be selected to ensure that the V2X-LTE is as strong as possible relative to the V2X-NR signal. In this way, even if the V2X-NR signal is stronger than the V2X-LTE at both antennas 820, 830, selecting the antenna that provides the maximum signal ratio between the V2X-LTE and V2X-NR signals may minimize an extent to which the strong V2X-NR signal degrades performance of the V2X-LTE signal. With reference to the example shown in FIG. 8A, the controller 810 may select the first antenna 820 because the V2X-LTE signal is stronger than the V2X-NR signal at the first antenna 820, whereas the V2X-NR signal is stronger than the V2X-LTE signal at the second antenna 830 (e.g., the ratio of the V2X-LTE signal to the V2X-NR signal is higher at the first antenna 820). In some aspects, the selected antenna that provides a maximum signal ratio for the V2X-LTE signal may be coupled to the first input path 824, and the second input path 834 may be coupled to the other antenna to maintain diversity. For example, if the first input path 824 is coupled to the first antenna 820, the second input path 834 would be coupled to the second antenna 830 (or vice versa). Alternatively, in some aspects, the controller 810 may select the antenna that provides the highest overall reading for the V2X-LTE signal (e.g., without regard to the ratio between the V2X-LTE signal and the V2X-NR signal). Furthermore, in cases where the first input path 824 and the second input path 834 are coupled to a dedicated NR antenna, the second path 834 that is dedicated to processing V2X-NR signals may be cross-coupled to a shared LTE/NR antenna in order to allow proper MIMO operation for V2X-NR signals (e.g., different antennas, including a dedicated NR antenna and shared LTE/NR antenna, are used to feed the NR receiver chain(s)).

As further shown in FIG. 8A, and by reference number 870, the controller 810 may adjust the receiver gain based at least in part on the quick WBEE reading for the V2X-LTE signal, and may apply a longer WBEE reading time based at least in part on the adjusted gain. For example, as shown in FIG. 8B, and by reference number 872, the gain may be adjusted to a second gain such that the start gain used in the first AGC iteration and the second gain used in the second AGC iteration cover the entire WBEE dynamic range. Alternatively, in cases where the second gain is located within the portion of the WBEE dynamic range covered by the first AGC iteration, the second AGC iteration may provide a longer accumulation time and therefore a finer resolution (e.g., smaller error) within the portion of the WBEE dynamic range relative to the first AGC iteration that is performed with a short accumulation time and a large error.

As further shown in FIG. 8A, and by reference number 880, the controller 810 may select a final gain to optimize performance of the V2X-LTE signal based at least in part on the long WBEE reading performed in the second AGC iteration. For example, as shown in FIG. 8B, and by reference number 882, the final selected gain may be within the overall WBEE dynamic range covered by the first AGC iteration and the second AGC iteration. Alternatively, as described above, the final selected gain may be within only the portion of the WBEE dynamic range covered by the first AGC iteration.

As indicated above, FIGS. 8A-8B are provided as examples. Other examples may differ from what is described with respect to FIGS. 8A-8B.

FIG. 9 is a diagram illustrating an example process 900 performed, for example, by a UE, in accordance with various aspects of the present disclosure. Example process 900 is an example where a UE (e.g., UE 120, UE 410, and/or the like) performs operations that relate to concurrent reception of multiple RATs based on switched diversity.

As shown in FIG. 9, in some aspects, process 900 may include receiving a first signal associated with a first RAT (block 910). For example, the UE (e.g., using antenna 252, DEMOD 254, MIMO detector 256, receive processor 258, controller/processor 280, memory 282, and/or the like) may receive a first signal associated with a first RAT, as described above.

As further shown in FIG. 9, in some aspects, process 900 may include receiving a second signal associated with a second RAT (block 920). For example, the UE (e.g., using antenna 252, DEMOD 254, MIMO detector 256, receive processor 258, controller/processor 280, memory 282, and/or the like) may receive a second signal associated with a second RAT, as described above.

As further shown in FIG. 9, in some aspects, process 900 may include coupling, via one or more switches and based at least in part on respective energy levels associated with the first signal and the second signal satisfying one or more conditions, an output from a front end of at least one receiver chain associated with the second RAT to one or more receiver chains associated with the first RAT (block 930). For example, the UE (e.g., using antenna 252, DEMOD 254, MIMO detector 256, receive processor 258, controller/processor 280, memory 282, and/or the like) may couple, via one or more switches and based at least in part on respective energy levels associated with the first signal and the second signal satisfying one or more conditions, an output from a front end of at least one receiver chain associated with the second RAT to one or more receiver chains associated with the first RAT, as described above.

Process 900 may include additional aspects, such as any single aspect or any combination of aspects described below and/or in connection with one or more other processes described elsewhere herein.

In a first aspect, the UE estimates a first energy level associated with the first signal and a second energy level associated with the second signal, and the one or more conditions are satisfied when the first energy level fails to satisfy a first threshold and the second energy level satisfies a second threshold, or when a ratio of the first energy level to the second energy level fails to satisfy a third threshold.

In a second aspect, alone or in combination with the first aspect, the UE estimates the energy level associated with the first signal after a first AGC iteration performed prior to coupling the output from the front end of the at least one receiver chain associated with the second RAT to the one or more receiver chains associated with the first RAT, estimates the energy level associated with the first signal after a second AGC iteration performed after coupling the output from the front end of the at least one receiver chain associated with the second RAT to the one or more receiver chains associated with the first RAT, and determines whether to maintain the coupling of the output from the front end of the at least one receiver chain associated with the second RAT to the one or more receiver chains associated with the first RAT based at least in part on a comparison of the energy level associated with the first signal after the first AGC iteration and the energy level associated with the first signal after the second AGC iteration.

In a third aspect, alone or in combination with one or more of the first and second aspects, the UE maintains the coupling of the output from the front end of the at least one receiver chain associated with the second RAT to the one or more receiver chains associated with the first RAT based at least in part on the energy level associated with the first signal after the first AGC iteration exceeding the energy level associated with the first signal after the second AGC iteration.

In a fourth aspect, alone or in combination with one or more of the first through third aspects, the UE decouples, via the one or more switches, the output of the front end of the at least one receiver chain associated with the second RAT from the one or more receiver chains associated with the first RAT based at least in part on the energy level associated with the first signal after the first AGC iteration failing to exceed the energy level associated with the first signal after the second AGC iteration.

In a fifth aspect, alone or in combination with one or more of the first through fourth aspects, the first AGC iteration and the second AGC iteration are performed within a single symbol of a subframe.

In a sixth aspect, alone or in combination with one or more of the first through fifth aspects, the coupling of the output from the front end of the at least one receiver chain associated with the second RAT to the one or more receiver chains associated with the first RAT is maintained for at least a duration of the subframe.

In a seventh aspect, alone or in combination with one or more of the first through sixth aspects, the first AGC iteration is performed while the UE is operating the at least one receiver chain at a start gain that covers a portion of an overall wideband energy estimation dynamic range, and process 900 includes selecting, among multiple antennas, an antenna that provides a maximum ratio or a maximum energy level for the first signal based at least in part on the first AGC iteration.

In an eighth aspect, alone or in combination with one or more of the first through seventh aspects, the second AGC iteration is performed while the UE is operating the at least one receiver chain at a second gain, and process 900 includes selecting, within the overall wideband energy estimation dynamic range, a final gain providing the maximum ratio or the maximum energy level for the first signal based at least in part on the second AGC iteration.

In a ninth aspect, alone or in combination with one or more of the first through eighth aspects, the one or more switches couple the output from the front end of the at least one receiver chain associated with the second RAT to the one or more receiver chains associated with the first RAT between an external low noise amplifier and an internal low noise amplifier in a path from an antenna to an analog-to-digital converter.

In a tenth aspect, alone or in combination with one or more of the first through ninth aspects, the one or more receiver chains associated with the first RAT include a main receiver chain and a diversity receiver chain that are dedicated to the first RAT.

In an eleventh aspect, alone or in combination with one or more of the first through tenth aspects, the one or more receiver chains associated with the first RAT include a main receiver chain and a diversity receiver chain that share antennas and front ends with a set of receiver chains associated with the second RAT.

In a twelfth aspect, alone or in combination with one or more of the first through eleventh aspects, the one or more switches include one or more single pole single throw switches that cause the output from the front end of the at least one receiver chain to be coupled to the one or more receiver chains associated with the first RAT.

In a thirteenth aspect, alone or in combination with one or more of the first through twelfth aspects, the one or more switches include one or more single pole single throw switches that cause the output from the front end of the at least one receiver chain to be decoupled from a receive path associated with the second RAT.

In a fourteenth aspect, alone or in combination with one or more of the first through thirteenth aspects, the one or more switches include one or more single pole double throw switches that enable the one or more receiver chains associated with the first RAT to be coupled to either the output from the front end of the at least one receiver chain associated with the second RAT or a front end of the one or more receiver chains associated with the first RAT.

In a fifteenth aspect, alone or in combination with one or more of the first through fourteenth aspects, the output from the front end of the at least one receiver chain is coupled to a splitter device having a first port that couples to a receive path associated with the second RAT and a second port that couples to the one or more receiver chains associated with the first RAT.

In a sixteenth aspect, alone or in combination with one or more of the first through fifteenth aspects, the second port that couples to the one or more receiver chains associated with the first RAT is terminated with one or more resistive devices when each of the one or more switches that couple the output from the front end of the at least one receiver chain to the one or more receiver chains associated with the first RAT are in an open state.

In a seventeenth aspect, alone or in combination with one or more of the first through sixteenth aspects, the first RAT is an LTE RAT and the second RAT is an NR RAT.

In an eighteenth aspect, alone or in combination with one or more of the first through seventeenth aspects, the coupling causes the at least one receiver chain associated with the first RAT and the one or more receiver chains associated with the second RAT to be coupled to a dedicated antenna associated with the second RAT, and the coupling further causes the at least one receiver chain associated with the second RAT to be cross-coupled to a shared antenna associated with the first RAT and the second RAT.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

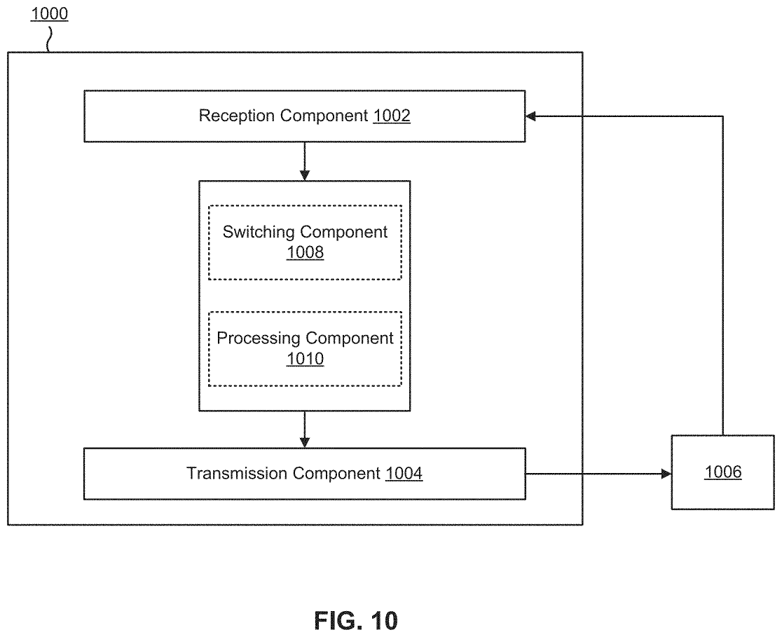

FIG. 10 is a block diagram of an example apparatus 1000 for wireless communication. The apparatus 1000 may be a UE (e.g., UE 120, UE 410, and/or the like), or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include one or more of a switching component 1008 or a processing component 1010, among other examples.

In some aspects, the apparatus 1000 may be configured to perform one or more operations described herein in connection with FIGS. 4A-4B, FIGS. 5A-5C, FIGS. 6A-6C, FIG. 7, and/or FIGS. 8A-8B. Additionally or alternatively, the apparatus 1000 may be configured to perform one or more processes described herein, such as process 900 of FIG. 9. In some aspects, the apparatus 1000 and/or one or more components shown in FIG. 10 may include one or more components of the UE described above in connection with FIG. 2, FIG. 3, FIGS. 4A-4B, FIGS. 5A-5C, FIGS. 6A-6C, FIG. 7, and/or FIGS. 8A-8B. Additionally, or alternatively, one or more components shown in FIG. 10 may be implemented within one or more components described above in connection with FIG. 2, FIG. 3, FIGS. 4A-4B, FIGS. 5A-5C, FIGS. 6A-6C, FIG. 7, and/or FIGS. 8A-8B. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

Furthermore, in some aspects, the reception component 1002 may include multiple antennas that are arranged to concurrently or simultaneously receive one or more V2X-LTE signals and one or more V2X-NR signals from the apparatus 1006 (e.g., a base station 110, a UE 120, an infrastructure device, and/or the like). For example, the reception component 1002 may include multiple receiver chains that include one or more antennas, front ends, receive paths, and/or the like. In some aspects, the multiple receiver chains may include one or more independent receiver chains with separate antennas, front ends, receive paths, and/or the like that are dedicated to processing a certain RAT type (e.g., V2X-LTE signals, V2X-NR signals, and/or the like). Additionally, or alternatively, the multiple receiver chains may include one or more shared receiver chains in which separate receive paths that support different RAT types share one or more antennas, front end components, and/or the like. Furthermore, in some aspects, the reception component 1002 may include one or more switches, splitter devices, resistive devices, and/or the like to enable an output from a front end of an independent receiver chain associated with an NR RAT to be coupled to a receiver chain associated with an LTE RAT in situations where concurrent reception of a V2X-LTE signal and a V2X-NR signal may degrade performance for the V2X-LTE signal. In some aspects, the reception component 1002 may include an antenna (e.g., antenna 252), a receive processor (e.g., receive processor 258), a controller/processor (e.g., controller/processor 280), a transceiver, a receiver, and/or the like.

The transmission component 1004 may transmit communications, such as reference signals, control information, data communications, V2X signals, V2X data, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The switching component 1008 may estimate energy levels associated with a V2X-LTE signal and a V2X-NR signal that are concurrently received by the reception component 1002. In some aspects, the switching component 1008 may determine whether respective energy levels associated with the V2X-LTE signal and the V2X-NR signal satisfy one or more conditions and communicate with the reception component 1002 to cause an output from the front end of the independent receiver chain associated with the NR RAT to be coupled to the receiver chain associated with the LTE RAT when the respective energy levels associated with the V2X-LTE signal and the V2X-NR signal satisfy the one or more conditions (e.g., where the V2X-LTE signal is relatively weak, fails to satisfy a threshold, and/or the like and the V2X-NR signal is relatively strong, and/or the like). In some aspects, the switching component 1008 may include a processor (e.g., controller/processor 280, receive processor 258, and/or the like).

The processing component 1004 may receive a processed V2X signal from the reception component 1002 and further process V2X data associated the processed V2X signal. For example, in some aspects, the V2X data may include a basic safety message (BSM), a traffic information message (TIM), a signal phase and time (SPAT) message, a MAP message to convey geographic road information, a cooperative awareness message (CAM), a distributed environment notification message (DENM), an in-vehicle information (IVI) message, and/or the like. In some aspects, the V2X data may include data relevant to operation of a vehicle associated with the apparatus 1000. In some aspects, the processing component 1010 may include a processor (e.g., controller/processor 280, receive processor 258, and/or the like).

The apparatus 1000 may include additional components that perform each of the blocks of the algorithm in the aforementioned process 900 of FIG. 9 and/or the like. Each block in the aforementioned process 900 of FIG. 9 and/or the like may be performed by a component and the apparatus 1000 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of components (e.g., one or more components) shown in FIG. 10 may perform one or more functions described as being performed by another set of components shown in FIG. 10.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a first signal associated with a first radio access technology (RAT);
receiving a second signal associated with a second RAT; and
coupling, via one or more switches and based at least in part on respective energy levels associated with the first signal and the second signal satisfying one or more conditions, an output from a front end of at least one receiver chain associated with the second RAT to one or more receiver chains associated with the first RAT.

2. The method of claim 1, further comprising:
estimating a first energy level associated with the first signal and a second energy level associated with the second signal, wherein the one or more conditions are satisfied when the first energy level fails to satisfy a first threshold and the second energy level satisfies a second threshold, or when a ratio of the first energy level to the second energy level fails to satisfy a third threshold.

3. The method of claim 1, further comprising:
estimating the energy level associated with the first signal after a first automatic gain control (AGC) iteration performed prior to coupling the output from the front end of the at least one receiver chain associated with the second RAT to the one or more receiver chains associated with the first RAT;
estimating the energy level associated with the first signal after a second AGC iteration performed after coupling the output from the front end of the at least one receiver chain associated with the second RAT to the one or more receiver chains associated with the first RAT; and
determining whether to maintain the coupling of the output from the front end of the at least one receiver chain associated with the second RAT to the one or more receiver chains associated with the first RAT based at least in part on a comparison of the energy level associated with the first signal after the first AGC iteration and the energy level associated with the first signal after the second AGC iteration.

4. The method of claim 3, further comprising:
maintaining the coupling of the output from the front end of the at least one receiver chain associated with the second RAT to the one or more receiver chains associated with the first RAT based at least in part on the energy level associated with the first signal after the first AGC iteration exceeding the energy level associated with the first signal after the second AGC iteration.

5. The method of claim 3, further comprising:
decoupling, via the one or more switches, the output of the front end of the at least one receiver chain associated with the second RAT from the one or more receiver chains associated with the first RAT based at least in part on the energy level associated with the first signal after the first AGC iteration failing to exceed the energy level associated with the first signal after the second AGC iteration.

6. The method of claim 3, wherein the first AGC iteration and the second AGC iteration are performed within a first symbol of a subframe, and wherein the coupling of the output from the front end of the at least one receiver chain associated with the second RAT to the one or more receiver chains associated with the first RAT is maintained for at least a duration of the subframe.

7. The method of claim 3, wherein the first AGC iteration is performed while the UE is operating the at least one receiver chain at a start gain that covers a portion of an overall wideband energy estimation dynamic range, and wherein the method further comprises selecting, among multiple antennas, an antenna that provides a maximum ratio or a maximum energy level for the first signal based at least in part on the first AGC iteration.

8. The method of claim 7, wherein the second AGC iteration is performed while the UE is operating the at least one receiver chain at a second gain, and wherein the method further comprises selecting, within the overall wideband energy estimation dynamic range, a final gain providing the maximum ratio or the maximum energy level for the first signal based at least in part on the second AGC iteration.

9. The method of claim 1, wherein the one or more switches couple the output from the front end of the at least one receiver chain associated with the second RAT to the one or more receiver chains associated with the first RAT between an external low noise amplifier and an internal low noise amplifier in a path from an antenna to an analog-to-digital converter.

10. The method of claim 1, wherein the one or more receiver chains associated with the first RAT include one or more of a main receiver chain and a diversity receiver chain that are dedicated to the first RAT, or a main receiver chain and a diversity receiver chain that share antennas and front ends with a set of receiver chains associated with the second RAT.

11. The method of claim 1, wherein the one or more switches include one or more single pole single throw switches that cause the output from the front end of the at least one receiver chain to be coupled to the one or more receiver chains associated with the first RAT or decoupled from a receive path associated with the second RAT.

12. The method of claim 1, wherein the one or more switches include one or more single pole double throw switches that enable the one or more receiver chains associated with the first RAT to be coupled to either the output from the front end of the at least one receiver chain associated with the second RAT or a front end of the one or more receiver chains associated with the first RAT.

13. The method of claim 1, wherein the output from the front end of the at least one receiver chain is coupled to a splitter device having a first port that couples to a receive path associated with the second RAT and a second port that couples to the one or more receiver chains associated with the first RAT, and wherein the second port that couples to the one or more receiver chains associated with the first RAT is terminated with one or more resistive devices when each of the one or more switches that couple the output from the front end of the at least one receiver chain to the one or more receiver chains associated with the first RAT are in an open state.

14. The method of claim 1, wherein the coupling causes the at least one receiver chain associated with the first RAT and the one or more receiver chains associated with the second RAT to be coupled to a dedicated antenna associated with the second RAT, and wherein the coupling further causes the at least one receiver chain associated with the second RAT to be cross-coupled to a shared antenna associated with the first RAT and the second RAT.

15. A user equipment (UE) for wireless communication, comprising:
a memory; and
one or more processors operatively coupled to the memory, the memory and the one or more processors configured to:
receive a first signal associated with a first radio access technology (RAT);
receive a second signal associated with a second RAT; and
couple, via one or more switches and based at least in part on respective energy levels associated with the first signal and the second signal satisfying one or more conditions, an output from a front end of at least one receiver chain associated with the second RAT to one or more receiver chains associated with the first RAT.

16. The UE of claim 15, wherein the one or more processors are further configured to:
estimate a first energy level associated with the first signal and a second energy level associated with the second signal, wherein the one or more conditions are satisfied when the first energy level fails to satisfy a first threshold and the second energy level satisfies a second threshold, or when a ratio of the first energy level to the second energy level fails to satisfy a third threshold.

17. The UE of claim 15, wherein the one or more processors are further configured to:
estimate the energy level associated with the first signal after a first automatic gain control (AGC) iteration performed prior to coupling the output from the front end of the at least one receiver chain associated with the second RAT to the one or more receiver chains associated with the first RAT;
estimate the energy level associated with the first signal after a second AGC iteration performed after coupling the output from the front end of the at least one receiver chain associated with the second RAT to the one or more receiver chains associated with the first RAT; and
determine whether to maintain the coupling of the output from the front end of the at least one receiver chain associated with the second RAT to the one or more receiver chains associated with the first RAT based at least in part on a comparison of the energy level associated with the first signal after the first AGC iteration and the energy level associated with the first signal after the second AGC iteration.

18. The UE of claim 17, wherein the one or more processors are further configured to:
maintain the coupling of the output from the front end of the at least one receiver chain associated with the second RAT to the one or more receiver chains associated with the first RAT based at least in part on the energy level associated with the first signal after the first AGC iteration exceeding the energy level associated with the first signal after the second AGC iteration.

19. The UE of claim 17, wherein the one or more processors are further configured to:
decouple, via the one or more switches, the output of the front end of the at least one receiver chain associated with the second RAT from the one or more receiver chains associated with the first RAT based at least in part on the energy level associated with the first signal after the first AGC iteration failing to exceed the energy level associated with the first signal after the second AGC iteration.

20. The UE of claim 17, wherein the first AGC iteration and the second AGC iteration are performed within a first symbol of a subframe, and wherein the coupling of the output from the front end of the at least one receiver chain associated with the second RAT to the one or more receiver chains associated with the first RAT is maintained for at least a duration of the subframe.

21. The UE of claim 17, wherein the first AGC iteration is performed while the UE is operating the at least one receiver chain at a start gain that covers a portion of an overall wideband energy estimation dynamic range, and wherein the one or more processors are further configured to select, among multiple antennas, an antenna that provides a maximum ratio or a maximum energy level for the first signal based at least in part on the first AGC iteration.

22. The UE of claim 21, wherein the second AGC iteration is performed while the UE is operating the at least one receiver chain at a second gain, and wherein the one or more processors are further configured to select, within the overall wideband energy estimation dynamic range, a final gain providing the maximum ratio or the maximum energy level for the first signal based at least in part on the second AGC iteration.

23. The UE of claim 15, wherein the one or more switches couple the output from the front end of the at least one receiver chain associated with the second RAT to the one or more receiver chains associated with the first RAT between an external low noise amplifier and an internal low noise amplifier in a path from an antenna to an analog-to-digital converter.

24. The UE of claim 15, wherein the one or more receiver chains associated with the first RAT include one or more of a main receiver chain and a diversity receiver chain that are dedicated to the first RAT, or a main receiver chain and a diversity receiver chain that share antennas and front ends with a set of receiver chains associated with the second RAT.

25. The UE of claim 15, wherein the one or more switches include one or more single pole single throw switches that cause the output from the front end of the at least one receiver chain to be coupled to the one or more receiver chains associated with the first RAT or decoupled from a receive path associated with the second RAT.

26. The UE of claim 15, wherein the one or more switches include one or more single pole double throw switches that enable the one or more receiver chains associated with the first RAT to be coupled to either the output from the front end of the at least one receiver chain associated with the second RAT or a front end of the one or more receiver chains associated with the first RAT.

27. The UE of claim 15, wherein the output from the front end of the at least one receiver chain is coupled to a splitter device having a first port that couples to a receive path associated with the second RAT and a second port that couples to the one or more receiver chains associated with the first RAT, and wherein the second port that couples to the one or more receiver chains associated with the first RAT is terminated with one or more resistive devices when each of the one or more switches that couple the output from the front end of the at least one receiver chain to the one or more receiver chains associated with the first RAT are in an open state.

28. The UE of claim 15, wherein the coupling causes the at least one receiver chain associated with the first RAT and the one or more receiver chains associated with the second RAT to be coupled to a dedicated antenna associated with the second RAT, and wherein the coupling further causes the at least one receiver chain associated with the second RAT to be cross-coupled to a shared antenna associated with the first RAT and the second RAT.

29. A non-transitory computer-readable medium storing one or more instructions for wireless communication, the one or more instructions comprising:
one or more instructions that, when executed by one or more processors of a user equipment (UE), cause the one or more processors to:
receive a first signal associated with a first radio access technology (RAT);
receive a second signal associated with a second RAT; and
couple, via one or more switches and based at least in part on respective energy levels associated with the first signal and the second signal satisfying one or more conditions, an output from a front end of at least one receiver chain associated with the second RAT to one or more receiver chains associated with the first RAT.

30. An apparatus for wireless communication, comprising:
means for receiving a first signal associated with a first radio access technology (RAT);
means for receiving a second signal associated with a second RAT; and
means for coupling, based at least in part on respective energy levels associated with the first signal and the second signal satisfying one or more conditions, an output from a front end of at least one receiver chain associated with the second RAT to one or more receiver chains associated with the first RAT.
